(19) United States
(12) Patent Application Publication
(10) Pub. No.: US 2010/0275774 A1
(43) Pub. Date: Nov. 4, 2010

(54) BIAXIAL ALIGNMENT ASSEMBLY FOR FORCE DELIVERY DEVICE

(75) Inventor: Don Clemens, Spring, TX (US)

Correspondence Address: PATTERSON & SHERIDAN, L.L.P., 3040 POST OAK BOULEVARD, SUITE 1500, HOUSTON, TX, 77056, US

(73) Assignee: TSC OFFSHORE GROUP LIMITED, Houston, TX (US)

(21) Appl. No.: 12/770,359

(22) Filed: Apr. 29, 2010

Related U.S. Application Data
(60) Provisional application No. 61/174,263, filed on Apr. 30, 2009.

(51) Int. Cl. F16J 1/14; F16C 17/04

(52) U.S. Cl. 92/187; 384/243

(57) ABSTRACT

A method and apparatus for accommodating mis-alignment of a piston rod in a reciprocating force delivery device is provided. A piston rod is coupled to a piston by a pivot bearing disposed around the piston rod inside the piston. The pivot bearing contacts an internal surface of the piston and provides a biaxial pivot point, which may also be triaxial, for the piston rod inside the piston. The pivot point is located near the centroid of the piston, enabling forces not aligned with the axis of the piston to be decoupled into axial and transverse components. The force decoupling avoids rotational moment on the piston, minimizing the possibility of metal-to-metal contact between components of the piston and the cylinder liner.

### CROSS-REFERENCE TO RELATED APPLICATIONS

This application claims benefit of U.S. Provisional Patent Application Ser. No. 61/174,263 filed Apr. 30, 2009, and incorporated herein by reference.

### BACKGROUND OF THE INVENTION

1. Field of the Invention

Embodiments of the invention relate to accessories for reciprocating force delivery devices. More specifically, embodiments disclosed herein relate to alignment devices and methods for a reciprocating piston and cylinder device.

2. Description of the Related Art

Production of oil and gas is a trillion dollar industry. To get oil and gas out of the earth, large costly equipment is used under extreme conditions. For example, reciprocating pumps that generate very high pressures are used for pumping liquids into and out of holes that are miles deep. Such pumps are either pumping against the pressure of fluids trapped beneath millions of tons of rock or taking suction of those fluids, so they must be functional for long periods of time under extreme stress.

One example of a reciprocating pump that routinely develops pressures of several thousand pounds per square inch is a drilling fluid pump. Drilling fluid (also called “drilling mud”) is a dense, viscous substance pumped into an active drilling hole to cool the drilling bit, lubricate the drill stem, support the walls of the wellbore, discourage premature entry of fluids into the wellbore, reveal the presence of oil or gas in a drilling formation, and carry cuttings to the surface where they can be removed. Higher viscosity drilling fluid is able to carry more and heavier cuttings, so additives are frequently used to increase viscosity. Pumping a high viscosity, high density fluid into a highly pressurized wellbore through miles of pipe requires very high pressure.

Reciprocating force delivery devices such as drilling fluid pumps operate by guiding a piston along a cylinder. One end of the cylinder is coupled to a fluid manifold which admits fluid when the piston is retracted. When the piston is advanced the fluid is forced from the manifold under pressure. The piston is generally driven by a rod or rod assembly coupled to a motor.

Pistons in reciprocating force delivery devices usually have a metal base behind a non-metal or compliant body that contacts the cylinder on all sides. The metal base is usually smaller than the body, so the metal base does not contact the metal cylinder. Such metal-to-metal contact may result in scoring or gouging, which can cause leakage around the piston and require stoppage of the pump to replace the cylinder.

Contact of the metal base with the metal cylinder may be caused by mis-alignment of the piston rod or rod assembly. Such mis-alignment causes a slight rotation of the piston, which may bring the metal base into contact with the metal cylinder. Frequent production outages due to drilling fluid pump failures are expensive, and today require that a considerable collection of spare parts and equipment be kept at the pump site, which may be far from any available supplies. Maintaining inventory of spare parts with frequent outages can be logistically challenging. Thus, there is a continuing need for reliable alignment arrangements for reciprocating piston and cylinder devices.

### SUMMARY OF THE INVENTION

Embodiments disclosed herein generally provide a piston assembly comprising a rod and a piston coupled to the rod by a pivot bearing inside the piston.

Other embodiments provide a piston assembly for a reciprocating pump, comprising a reciprocating drive, a thrust rod coupled to the reciprocating drive, a piston rod coupled to the thrust rod, a piston coupled to the piston rod and slidably disposed within a cylinder, a first alignment assembly disposed within the piston and coupling the piston to the piston rod, and a second alignment assembly coupling the thrust rod to the piston rod.

Other embodiments provide a method of maintaining alignment of a piston coupled to a piston rod, comprising disposing a pivot member on the piston rod inside the piston, locating the pivot member at a pivot point displaced from a centroid of the piston by no more than 20% of the length of the piston, and sizing the pivot member to contact an inside surface of the piston to form a seal.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side view of a piston assembly according to an embodiment of the invention.

FIG. 2A is a cross-sectional view of the piston 110 of FIG. 1.

FIG. 2B is a cross-sectional view of a portion of the piston assembly of FIG. 1.

FIG. 3 is a force vector diagram describing forces acting on the piston assembly of FIG. 1.

FIG. 4 is a cross-sectional detail view of another portion of the piston assembly of FIG. 1.

FIG. 5 is a schematic side view of a reciprocating force delivery device according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein generally provide methods and apparatus for maintaining alignment of a piston assembly for a reciprocating force delivery device. Reciprocating force delivery devices which may benefit from embodiments disclosed herein include, but are not limited to, reciprocating pumps and compressors having a piston slidably disposed within a cylinder. A rod coupled to the piston is also coupled to a reciprocating drive, which may be a rotary cam in some embodiments. The reciprocating drive is generally coupled to a motor, which provides rotary motion. The reciprocating drive converts the rotary motion of the motor into a reciprocating motion of the rod.

A thrust rod is generally coupled to the reciprocating drive by a crosshead member or other linkage, and a piston rod is coupled to the thrust rod by a coupling. The piston is disposed near the end of the piston rod, which moves the piston inside a cylinder. The piston generally comprises a metal base and a compliant body. The compliant body may be a polymer, such as a hard rubber material, in some embodiments. The compliant body contacts an inner surface of the cylinder to form a seal. The metal base is generally slightly smaller than the compliant member to provide space between the metal base of the piston and the metal inner surface of the cylinder.

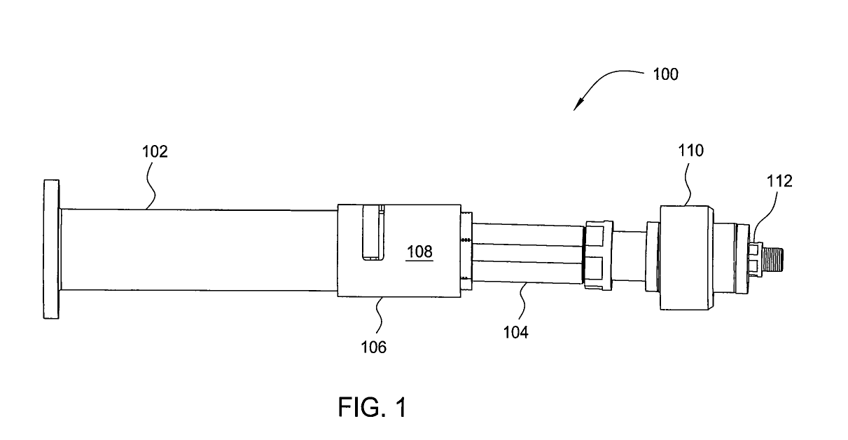

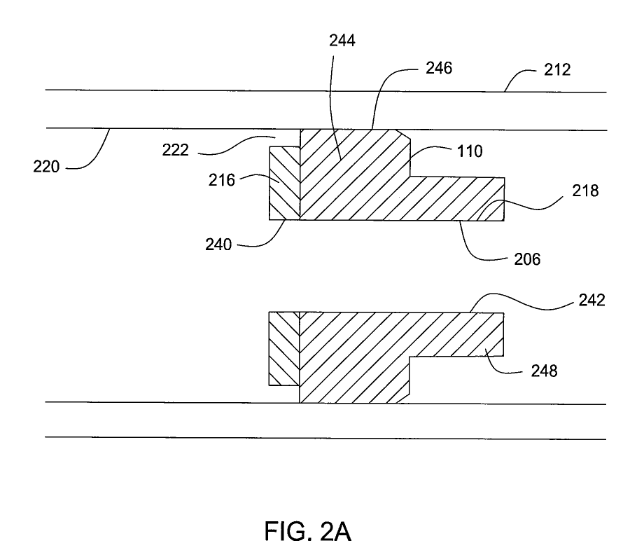

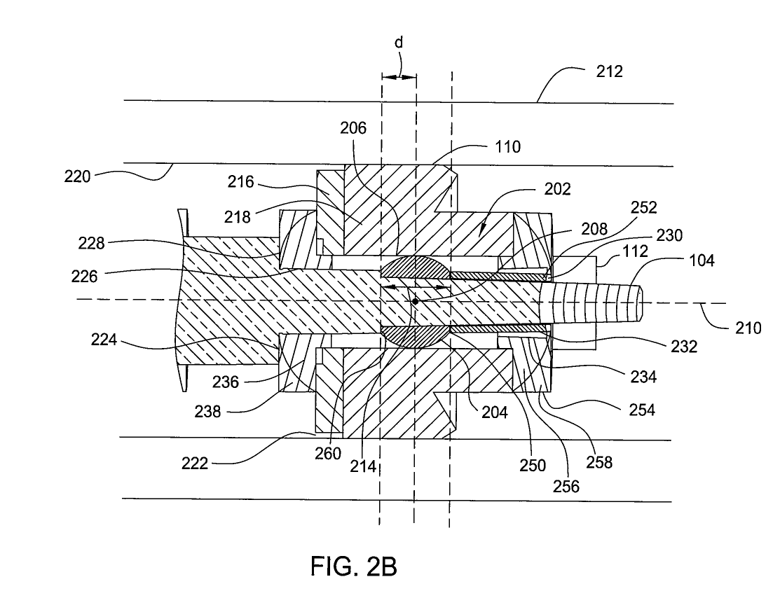

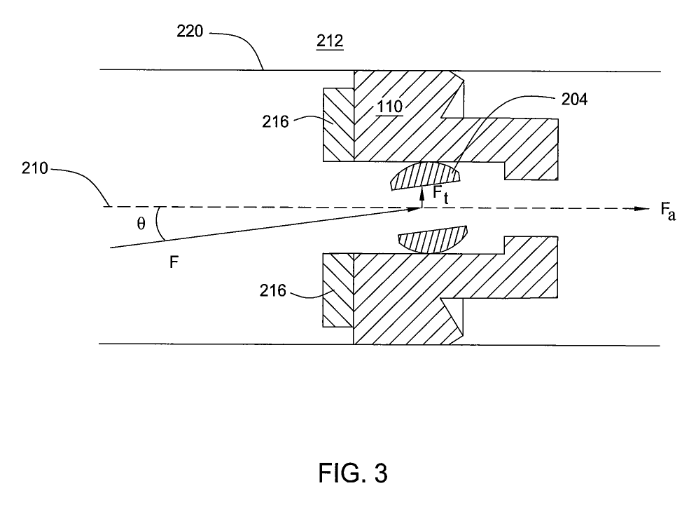

FIG. 1 is a side view of a piston assembly 100 according to one embodiment. A thrust rod 102 is coupled to a piston rod 104 by a coupling 106, positioned inside a collar 108. The coupling 106 enables the piston rod 104 to move with respect to the thrust rod 102 without becoming uncoupled. A piston 110 is coupled to the piston rod 104 by an alignment assembly disposed inside the piston, discussed in more detail below in conjunction with FIGS. 2 and 3. The alignment assembly allows the piston rod 104 to move with respect to the piston 110 without becoming uncoupled. The piston 110 is secured to the piston rod 104 by a nut 112 attached to the threaded end of the piston rod 104.

FIG. 2A is a cross-sectional view of the piston 110 of FIG. 1. The piston 110 is disposed within a metal cylinder 212. The piston 110 comprises a metal base 216, which may be any hardened steel suitable for the service in which the device is employed, and a compliant body 218, which may be a polymer or plastic material of sufficient strength to withstand the forces developed in the cylinder 212. The piston 110 has a passage defined by an inner surface 206, which comprises an inner surface 240 of the metal base 216 and an inner surface 242 of the compliant body 218. The inner surface 240 of the metal base 216 has a diameter that is substantially equal to the diameter of the inner surface 242 of the compliant body 218. The metal base 216 and the compliant body 218 thus form a substantially smooth passage for admitting the piston rod 104. The compliant body 218 has a first portion 244 with an outer surface 246 that contacts an inner surface 220 of the cylinder 212. The first portion 244 thus has an outer diameter that is substantially equal to an inner diameter of the cylinder 212. The compliant body 218 also has a second portion 248, contiguous and concentric with the first portion 244, with an outer diameter smaller than that of the first portion 244. The metal base has an outer diameter that is smaller than that of the first portion 244, as well, forming a gap 222 between the metal base 216 and the cylinder 212 to prevent contact between the metal base 216 and the inner surface 220 of the cylinder 212. The gap 222 is usually minimized to minimize shear forces on the compliant body 218 of the piston 110.

FIG. 2B is a cross-sectional view of a portion of the piston assembly of FIG. 1. A first alignment assembly 202 is disposed within the piston 110, inside the passage defined by the inner surfaces 242 and 240 (FIG. 2A) of the compliant body 218 and the metal base 216, and couples the piston 110 to the piston rod 104. The first alignment assembly 202 comprises a pivot bearing 204, which may be an integral part of the piston rod 104 in some embodiments, or a pivot sleeve in other embodiments. The pivot bearing 204 has a spherical shape and an outer diameter substantially equal to the inner diameter of the compliant body 218, such that the pivot bearing 204 contacts the inner surface 206 of the piston 110. The pivot bearing 204 seats against an abutment 260 of the piston rod 104 that restrains motion of the pivot bearing 204 along the piston rod 104. The piston rod 104 has an outer diameter that is less than that of the pivot bearing 204, resulting in a space between the piston rod 104 and the inner surface 206 of the piston 110. In some embodiments, the pivot bearing 204 is a spherical member with a hole bored through it to admit the piston rod 104.

The piston 110 further comprises a first washer 224 disposed between the metal base 216 of the piston 110 and a shoulder 228 of the piston rod. The first washer 224 comprises a first metal portion 236 and a second metal portion 238, each portion having a spherical surface. The first metal portion 236 has a convex spherical surface facing away from the piston 110 and a lip for inserting into the passage extending through the piston 110. The second metal portion 238 has a concave spherical surface that mates with the convex spherical surface of the first metal portion 236 and seats against the shoulder 226 of the piston rod 104. The piston 110 further comprises a second washer 254 with a first metal portion 256 and a second metal portion 258. As with the first washer 224, the first metal portion 256 of the second washer 254 has a convex spherical surface facing away from the piston 110 and a lip for inserting into the passage extending through the piston 110. The second metal portion 258 has a concave spherical surface that mates with the first metal portion 256. The first washer 224 and the second washer 254 may be identical in all respects in some embodiments. In the embodiment of FIG. 2B, the second washer 254 has an outer diameter that is substantially equal to the outer diameter of the second portion 248 of the compliant body 218 of the piston 110. The nut 112 fastens the second metal portion 258 of the second washer 254 to the piston rod 104, and couples the piston 110 to the piston rod 104 by the axial force of the second metal portion 258 of the second washer 254 on the first metal portion 256 of the second washer 254, but the first metal portion 256 of the second washer 254 is coupled to the piston 110 by the lip inserted into the central passage. The first metal portion 256 of the second washer 254 is therefore able to move with the piston 110, whereas the second metal portion 258 of the second washer 254 moves with the piston rod 104. The spherical contact surface between the two portions of the second washer 254 enables this movement. Similar movement between the two portions of the first washer 224 is enabled by the similar coupling of the first metal portion 236 of the first washer 224 to the piston 110 and the second metal portion 238 of the first washer 224 to the piston rod 104.

The piston 110 further comprises a collar 230 with a first end 250 abutting the pivot bearing and a second end 252 abutting the second metal portion 258 of the second washer 254. The collar 230 has an outer diameter 232 that is less than an inner diameter 234 of the first metal portion 256 of the second washer 254, forming a gap between the collar 230 and the second metal portion 258 of the second washer 254. The collar 230 holds the pivot bearing 204 in place against the abutment 260 in embodiments wherein the pivot bearing 204 is a discrete part. In an embodiment wherein the pivot bearing 204 is an integral part of the piston rod 104, the collar 130 may be omitted.

The pivot bearing 204 generally allows the piston rod 104 to move along two orthogonal axes, each of which is substantially orthogonal to the major axis 210 of the piston 110. If the major axis of the piston rod 104 is not precisely aligned with the major axis 210 of the piston 110, the force delivered by the piston rod 104 to the piston 110 is decoupled at the center of the pivot bearing 204 into a force delivered along the major axis 210 of the piston 110, and the cylinder 212, and a force delivered substantially orthogonal to the major axis 210 of the piston 110. Thus, in some embodiments, the pivot bearing 204 is a biaxial pivot bearing, because the pivot point 208 defined thereby is a biaxial pivot point for the piston rod 104 with respect to the piston 110.

The pivot bearing 204 defines a pivot point 208 that may be located at a centroid of the piston 110. In other embodiments, the pivot point 208 may be spaced apart from the centroid of the piston 110 by a distance “d” up to about 20% of the length of the piston 110, such as less than about 15% of the length of the piston 110, for example no more than about 10% of the length of the piston 110, as shown by arrows 214. Locating the pivot point 208 at or near the centroid of the piston 110 reduces rotational moment on the piston 110 due to the decoupled lateral force at the pivot point 208, which in turn reduces the possibility that the metal base 216 of the piston 110 will contact the inner surface 220 of the cylinder 212 due to twisting of the piston 110 in the cylinder 212.

In some embodiments, the pivot bearing 204 of the first alignment assembly 202 may define a triaxial pivot point that allows the piston rod 104 to rotate around three axes with respect to the piston 110. In addition to the two axes described above, the piston 110 may also move about its major axis 210. This decouples any torque on the piston 110 from the piston rod 104 as the piston 110 is advanced and retracted within the cylinder 212.

In the embodiment of FIG. 2B, the piston rod 104 is shown having a tapered profile with a diameter that diminishes uniformly from the shoulder 224 of the piston rod 104 to the threaded end of the piston rod 104, with a step change in diameter at the abutment 260. The collar 230 of FIG. 2B thus has an inner diameter that decreases uniformly as the outer diameter of the piston rod 104 decreases. In alternate embodiments, the piston rod 104 may have a substantially constant diameter between the shoulder 224 and the abutment 260, and between the abutment 260 and the threaded end. In such embodiments, the collar 230 may be a restraining ring. It should be noted that using a piston rod with a tapered profile, such as the piston rod 104 of FIG. 2B, may enable eliminating the abutment 260 because the pivot bearing 204 may slide over the piston rod 104 to the point at which the diameter of the piston rod 104 equals the inner surface diameter of the pivot bearing 204. The collar 230 then holds the pivot bearing 204 at that location on the piston rod 104.

FIG. 3 is a force vector diagram describing forces applied to the piston 110 by the piston rod. The piston rod (FIG. 2) applies a force F along the major axis of the piston rod. The force F is mis-aligned with respect to the major axis 210 of the piston 110 by an angle θ. The pivot bearing 204 rotates with the piston rod to accommodate the mis-alignment and separates the applied force F into components Fₐ along the major axis 210 of the piston 110 and Fₜ transverse to the major axis 210 of the piston 110. The component forces relate to the applied force as follows:

Fₐ=Fcos θ

Fₜ=Fsin θ

Each component force is applied through, or near to, the centroid of the piston 110, so the rotational moment on the piston 110 is minimized. The transverse force Fₜ is therefore spread substantially evenly along the inner surface 220 of the cylinder 212, preventing the metal base 216 of the piston 110 from contacting the metal inner surface 220 of the cylinder 212. In most embodiments, the mis-alignment angle θ will be less than about 5°, such as less than about 3°, for example less than about 1°. Dimensions of the piston 110 may be adjusted to accommodate desired degrees of mis-alignment by adjusting the inner diameter 234 of the first washer 224 and, if needed, the inner diameter of the piston 110. Enlarging the inner diameter of the piston 110 will also require enlarging the outer diameter of the pivot bearing 204 to maintain contact with the inner surface 206 of the piston 110.

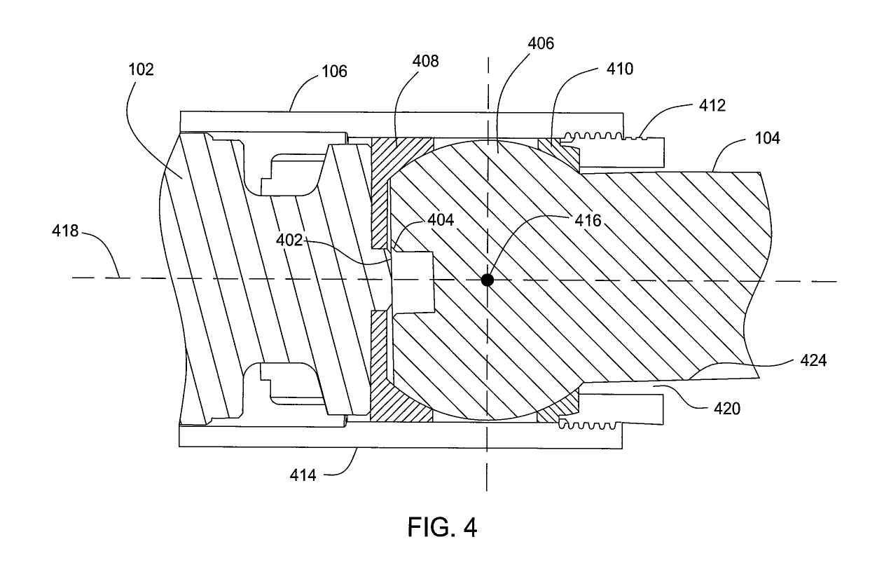

The piston rod 104 is generally coupled to the thrust rod 102 by a movable coupling disposed inside the collar 108. FIG. 4 is a cross-sectional view of the coupling of the thrust rod 102 and the piston rod 104. The thrust rod 102 and the piston rod 104 are coupled by a second alignment assembly 414 inside a collar 108. The second alignment assembly 414 comprises an extension 402 of the thrust rod 102 that mates with a recess 404 in the end of the piston rod 104. The mating relationship allows the piston rod 104 to move with respect to the thrust rod 102 in the event the two rods are not aligned. The second alignment assembly 414 further comprises a curved end portion 406 of the piston rod 104 that extends into the collar 108 and seats in a curved washer 408 disposed within the collar 108. The second alignment assembly 414 further comprises a second curved washer 410 that retains the curved end portion 406 of the piston rod 104, and a nut collar 412 that fastens the coupling. In some embodiments, the curved end portion 406 of the piston rod 104 may be a second pivot bearing of the piston rod 104, such as a second pivot sleeve disposed around an end of the piston rod 104. In some embodiments, the curved end portion 406 of the piston rod 104 may have a spherical shape.

The curved end portion 406 of the piston rod 104 defines a second pivot point 416 inside the collar 108. The second pivot point 416 allows the piston rod 104 to move about two orthogonal axes with respect to the thrust rod 102, each orthogonal to a major axis 418 of the thrust rod 102. In some embodiments, the second pivot point 416 may allow movement about three substantially orthogonal axes, such as the two axes described above and a major axis of the piston rod 104. The curved end portion 406 of the piston rod 104 may thus be a biaxial pivot point or a triaxial pivot point in some embodiments.

In most embodiments, the angle of mis-alignment between the thrust rod 102 and the piston rod 104 will be less than about 5°, such as less than about 3°, for example less than about 1°. The mis-alignment angle is accommodated by a gap 420 between an inner surface 422 of the nut collar 412 and an outer surface 424 of the piston rod 104. A larger angle of mis-alignment may be accommodated by adjusting dimensions of components of the second alignment assembly 414, such as the thickness of the second curved washer 410 and the inner diameter of the nut collar 412.

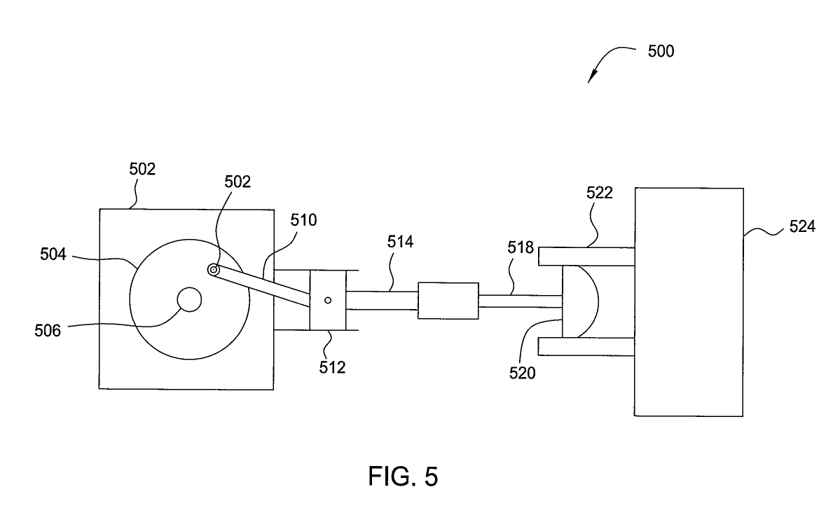

FIG. 5 is a schematic side view of a reciprocating force delivery device 500 according to another embodiment. The device 500 has a motor 502 coupled to a rotating plate 504 by a rotating shaft (not shown) at a rotation point 506 on the rotating plate 504. A linkage 510 is attached to the rotating plate 504 at a linkage point 508, and is coupled to a crosshead member 512. The crosshead member 512 and linkage 510 form a reciprocating drive that transforms the rotary motion of the motor into linear reciprocating motion of the piston rod assembly. In some embodiments, the rotating plate 504 may be attached to the rotating shaft at an eccentric point, such that the rotating plate 504 operates as a cam, which may be coupled to the crosshead member 512 by direct force, for example by direct contact between the rotating plate 504 and the crosshead member 512, eliminating the linkage 510.

A thrust rod 514 is coupled to the crosshead member 512. The thrust rod 514 is coupled to a piston rod 518 by a coupling, which may be a biaxial pivot coupling as described above in connection with FIG. 4. A piston 520 is disposed within a cylinder 522 and coupled to the piston rod 518. The cylinder 522 provides a pathway for delivering force generated by the motor to a fluid manifold 524 for impelling fluid through the fluid manifold 524.

The piston 520 is coupled to the piston rod 518 at a coupling point located inside the piston 520. The coupling is a biaxial pivot coupling allowing the piston rod to move about two substantially orthogonal axes, each substantially orthogonal to a major axis of the piston 520 and the cylinder 522. In some embodiments, the coupling may also be a triaxial pivot coupling. In some embodiments, the alignment assembly described above in connection with FIG. 2 may be used to couple the piston 520 to the piston rod 518.

While the foregoing is directed to embodiments of the invention, other and further embodiments of the invention may be devised without departing from the basic scope thereof.

What is claimed is:

1. A piston rod assembly, comprising:
a rod; and
a piston coupled to the rod by a pivot bearing disposed around the rod inside the piston.

2. The piston rod assembly of claim 1, wherein the pivot bearing is a biaxial pivot bearing.

3. The piston rod assembly of claim 1, wherein the pivot bearing is a triaxial pivot bearing.

4. The piston rod assembly of claim 1, wherein the pivot bearing is a sleeve.

5. The piston rod assembly of claim 1, wherein the pivot bearing is a sleeve having a spherical surface, wherein the sleeve contacts an inside surface of the piston.

6. The piston rod assembly of claim 2, wherein the pivot bearing forms a seal with an inner surface of the piston.

7. The piston rod assembly of claim 1, wherein the rod extends through the pivot bearing, and the pivot bearing forms a seal with an inside surface of the piston.

8. The piston rod assembly of claim 1, wherein the pivot bearing defines a pivot point that is located at a centroid of the piston.

9. The piston rod assembly of claim 1, further comprising a spacer inside the piston that maintains the relative position of the pivot bearing and the piston.

10. A piston assembly for a reciprocating pump, comprising:
a reciprocating drive;
a thrust rod coupled to the reciprocating drive;
a piston rod coupled to the thrust rod;
a piston coupled to the piston rod and slidably disposed within a cylinder;
a first alignment assembly disposed within the piston and coupling the piston to the piston rod; and
a second alignment assembly coupling the thrust rod to the piston rod.

11. The piston assembly of claim 10, wherein the first alignment assembly comprises a first pivot sleeve disposed about a first end of the piston rod.

12. The piston assembly of claim 11, wherein the second alignment assembly comprises a second pivot sleeve disposed about a second end of the piston rod.

13. The piston assembly of claim 12, wherein the second pivot sleeve is disposed within a collar coupled to the thrust rod.

14. The piston assembly of claim 13, wherein the first pivot sleeve defines a biaxial pivot point.

15. The piston assembly of claim 13, wherein the first pivot sleeve defines a triaxial pivot point.

16. The piston assembly of claim 14, wherein the first pivot sleeve contacts an inside surface of the piston to form a seal.

17. The piston assembly of claim 14, wherein the biaxial pivot point is located at a centroid of the piston.

18. The piston assembly of claim 14, wherein the biaxial pivot point is displaced from a centroid of the piston by no more than about 20% of a length of the piston.

19. A method of maintaining alignment of a piston coupled to a piston rod, comprising:
disposing a pivot member on the piston rod inside the piston;
locating the pivot member at a pivot point displaced from a centroid of the piston by no more than 10% of a length of the piston; and
sizing the pivot member to contact an inside surface of the piston to form a seal.

20. The method of claim 19, wherein the pivot member decouples a force directed along a major axis of the piston rod into a force directed along a major axis of the piston and a force orthogonal to the major axis of the piston.

21. A reciprocating force delivery device, comprising:
a motor;
a rotational coupling that couples the motor to a reciprocating drive; and
a piston rod coupled to the reciprocating drive at a first end and to a piston at a second end, wherein the piston moves with respect to the piston rod about a pivot point located inside the piston.

22. The device of claim 21, further comprising a pivot bearing disposed about the piston rod, wherein the pivot bearing defines the pivot point, and the pivot point is spaced apart from a centroid of the piston by a distance no more than about 20% of a length of the piston.

23. The device of claim 22, wherein the pivot bearing is a seal.

24. The device of claim 22, wherein the pivot bearing is a biaxial pivot bearing.
